(19) United States
(12) Patent Application Publication
(10) Pub. No.: US 2015/0040996 A1
(43) Pub. Date: Feb. 12, 2015

(54) Valved Cover Device

(71) Applicant: John P. Hanlon, Concordville, PA (US)

(72) Inventor: John P. Hanlon, Concordville, PA (US)

(21) Appl. No.: 14/498,518

(22) Filed: Sep. 26, 2014

Related U.S. Application Data
(63) Continuation-in-part of application No. 13/964,473, filed on Aug. 12, 2013.

(51) Int. Cl. F16K 24/04; E04H 4/12

(52) U.S. Cl. CPC F16K 24/04; E04H 4/1209
USPC 137/197

(57) ABSTRACT

A valved cover device prevents pump cavitation of a swimming pool pump by allowing air to be released through an open valve of a strainer cover. The device includes a strainer cover configured for positioning over a strainer housing for a swimming pool pump. An air-bleed valve extends into the strainer cover. The air-bleed valve is selectively manipulated wherein the air bleed valve is configured to vent an interior of the housing when the strainer cover is positioned over and closes an access opening into the interior of the housing. The air-bleed valve is configured for environmentally communicating with the interior of the housing wherein a gas is permitted to bleed outwardly through the strainer cover when the strainer cover closes the access opening and the air-bleed valve is actuated.

### CROSS-REFERENCE TO RELATED APPLICATIONS

This application is a continuation in part of application Ser. No. 13/964,473 filed on Aug. 12, 2013.

### BACKGROUND OF THE DISCLOSURE

### Field of the Disclosure

The disclosure relates to swimming pool maintenance devices and more particularly pertains to a new swimming pool maintenance device for preventing pump cavitation of a swimming pool pump by allowing air to be released through an open valve of a strainer cover.

### SUMMARY OF THE DISCLOSURE

An embodiment of the disclosure meets the needs presented above by generally comprising a strainer cover configured for positioning over a strainer housing for a swimming pool pump. An air-bleed valve extends into the strainer cover. The air-bleed valve is selectively manipulated wherein the air bleed valve is configured to vent an interior of the housing when the strainer cover is positioned over and closes an access opening into the interior of the housing. The air-bleed valve is configured for environmentally communicating with the interior of the housing wherein a gas is permitted to bleed outwardly through the strainer cover when the strainer cover closes the access opening and the air-bleed valve is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a valved cover device according to an embodiment of the disclosure.

FIG. 2 is a bottom view of an embodiment of the disclosure.

FIG. 3 is a cross-sectional view of an embodiment of the disclosure taken along line 3-3 of FIG. 1.

FIG. 4 is an in-use front view of an embodiment of the disclosure.

### DESCRIPTION OF THE PREFERRED EMBODIMENT

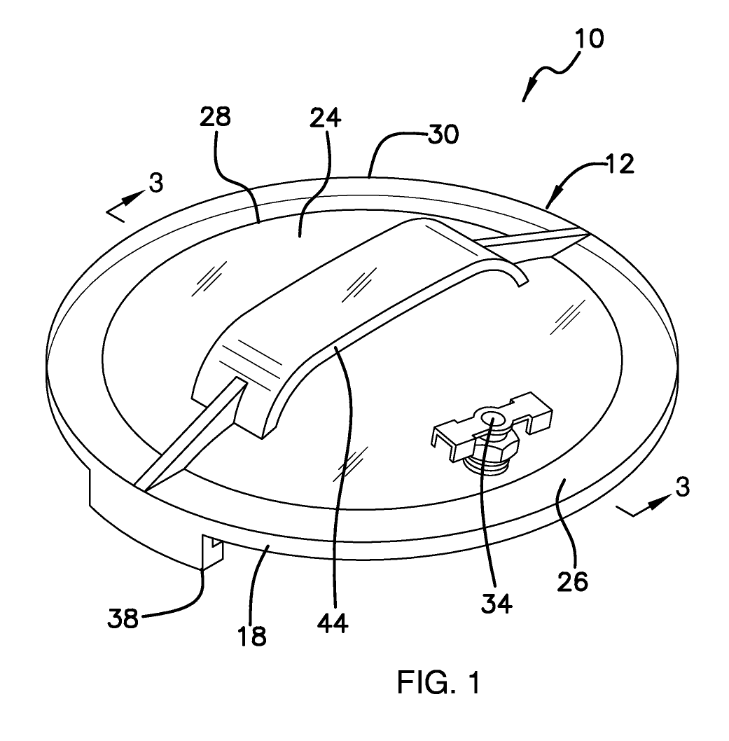

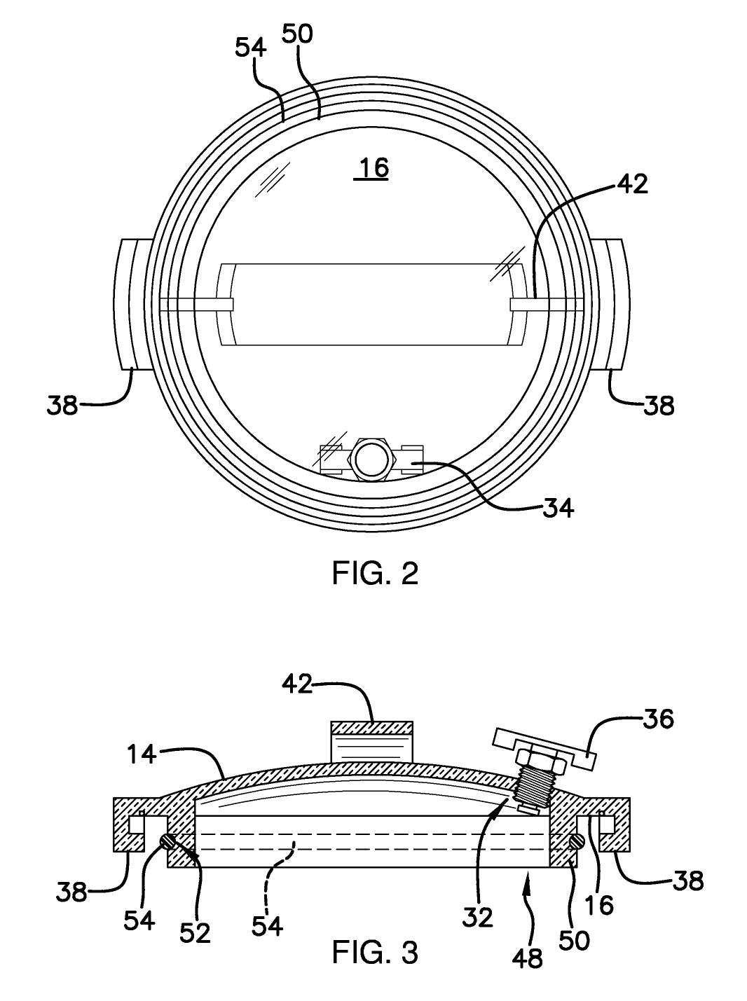

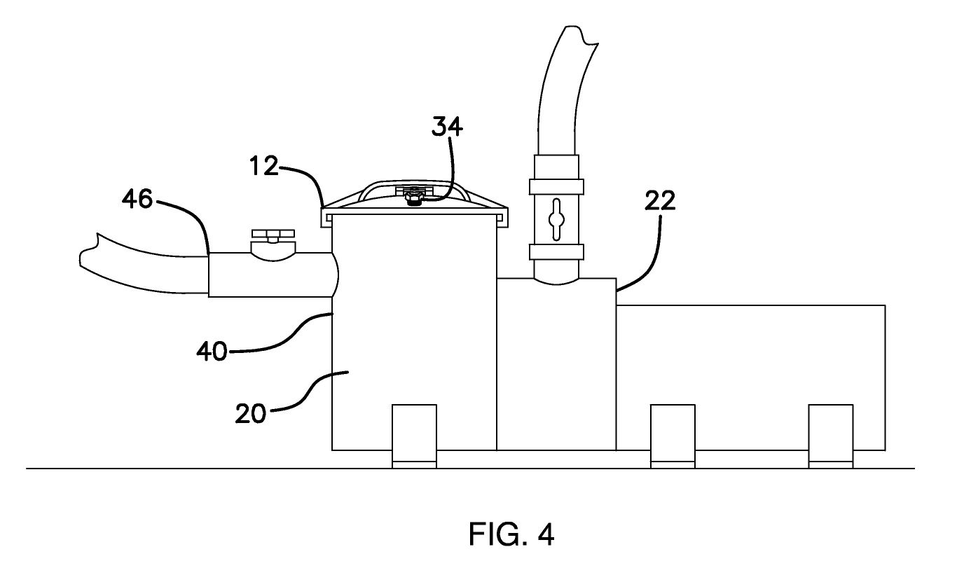

With reference now to the drawings, and in particular to FIGS. 1 through 4 thereof, a new swimming pool maintenance device embodying the principles and concepts of an embodiment of the disclosure and generally designated by the reference numeral 10 will be described.

As best illustrated in FIGS. 1 through 4, the valved cover device 10 generally comprises a strainer cover 12 having a top side 14, a bottom side 16, and a perimeter wall 18 attached to and extending between the top side 14 and the bottom side 16. The strainer cover 12 is configured for positioning over a strainer housing 20 for a swimming pool pump 22. The swimming pool pump 22 and strainer housing 20 are used in the conventional manner such that both the swimming pool pump 22 and strainer housing 20 are fluidly coupled to the swimming pool drain line 46 and thereby create suction through the drain line 46. The strainer cover 12 may be translucent. The strainer cover 12 has an inner section 24 and an outer section 26 defined by an inner edge 28 of the strainer cover 12. The outer section 26 terminates at an outer edge 30 of the strainer cover 12. The outer section 26 may be planar. The inner section 24 may be convexly arcuate.

An aperture 32 is positioned in the strainer cover 12. An air-bleed valve 34 extends through the aperture 32. A top end 36 of the air bleed valve 34 may extend outwardly of the top side 14. The air-bleed valve 34 is selectively manipulated wherein the air bleed valve 34 is configured to vent an interior of the housing 20 when the strainer cover 12 is positioned over and closes an access opening into the interior of the housing 20. The air-bleed valve 34 is configured for environmentally communicating with the interior of the housing 20 wherein a gas is permitted to bleed outwardly through the aperture 32 when the strainer cover 12 closes the access opening and the air-bleed valve 34 is actuated. Thus, as pressure builds inside the interior of the strainer housing 20, air is released through the air-bleed valve 34 when the air-bleed valve is actuated. In this manner, the air-bleed valve 34 is conventional whereby an opening is created in the air-bleed valve 34 to permit air to flow outwardly therethrough. The air-bleed valve 34 can be closed and sealed when fluid begins to spray outwardly through the air-bleed valve 34 to prevent fluid from exiting the strainer housing 20.

A first pair of flanges 38 is coupled to and extends outwardly from the perimeter wall 18. The first pair of flanges 38 is configured to frictionally engage a peripheral wall 40 of the housing 20 and form a seal between the strainer cover 12 and the housing 20. Preferably, the first pair of flanges 38 is diametrically opposed. A downwardly projecting base flange 48 is coupled to and extends around the bottom side 16 of the strainer cover 12. A circumferential wall 50 of the base flange 48 is offset from the perimeter wall 18 of the strainer cover 12. A groove 52 extends into the circumferential wall 50 of the base flange 46 and extends an entire circumference around the base flange 46. An o-ring 54 is positioned within the groove 52 to further seal the strainer cover 12 and the strainer housing 20 when the strainer cover 12 is positioned over the strainer housing 20. A handle 42 is coupled to the top side 14. The handle 42 may have an arcuate medial section 44 configured to facilitate grasping. The handle 42 may extend between the first pair of flanges 38.

In use, as stated above and shown in the Figures, the strainer housing 20 and swimming pool pump 22 are fluidly coupled to the swimming pool drain line 46 in a conventional manner. The strainer cover 12 is positioned on and sealed to the strainer housing 20 via the first pair of flanges 38 and the base flange 46. As pressure builds within the interior of the housing 20, selective manipulation of the valve 34 releases air outwardly through the valve 34. As fluid begins to flow outwardly through the valve 34, the valve 34 is again manipulated to close the valve 34. Prior inventions had required the pump 22 to be turned off and the strainer cover 12 removed to relieve pressure build-up within the housing 20. To the contrary, the current device 10 allows for continuous operation of a swimming pool since air bleeds outwardly through the valve 34 without having to remove the strainer cover 12 or turn off the pump 22

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A valved cover device comprising:
a strainer cover having a top side, a bottom side, and a perimeter wall attached to and extending between said top side and said bottom side, said strainer cover being configured for positioning over a strainer housing for a swimming pool pump; and
an air-bleed valve extending into said strainer cover, said air-bleed valve being selectively manipulated wherein said air bleed valve is configured to vent an interior of the strainer housing when said strainer cover is positioned over and closes an access opening into the interior of the strainer housing, said air-bleed valve being configured for environmentally communicating with the interior of the strainer housing wherein a gas is permitted to bleed outwardly through said strainer cover when said strainer cover closes the access opening and said air-bleed valve is actuated.

2. The device of claim 1, further comprising:
said strainer cover having an inner section and an outer section defined by an inner edge of said strainer cover; and
said outer section terminating at an outer edge of said strainer cover.

3. The device of claim 2, further comprising said inner section being convexly arcuate.

4. The device of claim 1, further comprising said strainer cover being translucent.

5. The device of claim 2, further comprising said outer section being planar.

6. The device of claim 1, further comprising:
an aperture positioned in said strainer cover, said air bleed valve extending through said aperture; and
wherein said aperture is configured to permit the gas to bleed outwardly therethrough when said strainer cover closes the access opening and said air-bleed valve is actuated.

7. The device of claim 1, further comprising a first pair of flanges coupled to and extending outwardly from said perimeter wall, said first pair of flanges being configured to frictionally engage a peripheral wall of the strainer housing and form a seal between said strainer cover and the strainer housing.

8. The device of claim 1, further comprising a handle coupled to said top side, said handle being having an arcuate medial section configured to facilitate grasping.

9. The device of claim 7, further comprising a handle coupled to said top side, said handle extending between said flanges.

10. The device of claim 1, further comprising:
a downwardly projecting base flange coupled to and extending around said bottom side of said strainer cover;
a circumferential wall of said base flange being offset from said perimeter wall of said strainer cover;
a groove extending into said circumferential wall of said base flange and extending an entire circumference around said base flange; and
an o-ring being positioned within said groove wherein said o-ring is configured to seal said strainer cover to the strainer housing when said strainer cover is positioned over the strainer housing.

11. A valved cover device comprising:
a strainer cover having a top side, a bottom side, and a perimeter wall attached to and extending between said top side and said bottom side, said strainer cover being configured for positioning over a strainer housing for a swimming pool pump, said strainer cover having an inner section and an outer section defined by an inner edge of said strainer cover, said inner section being convexly arcuate, said inner section being translucent, said outer section being planar and terminating at an outer edge of said strainer cover;
an aperture positioned in said strainer cover;
an air-bleed valve extending through said aperture, a top end of said air bleed valve extending outwardly of said top side, said air-bleed valve being selectively manipulated wherein said air bleed valve is configured to vent an interior of the housing when said strainer cover is positioned over and closes an access opening into the interior of the strainer housing, said air-bleed valve being configured for environmentally communicating with the interior of the strainer housing wherein a gas is permitted to bleed outwardly through said aperture when said strainer cover closes the access opening and said air-bleed valve is actuated;
a first pair of flanges coupled to and extending outwardly from said perimeter wall, said first pair of flanges being configured to frictionally engage a peripheral wall of the strainer housing and form a seal between said strainer cover and the strainer housing, said first pair of flanges being diametrically opposed;
a handle coupled to said top side, said handle being having an arcuate medial section configured to facilitate grasping, said handle extending between said flanges;
a downwardly projecting base flange coupled to and extending around said bottom side of said strainer cover;
a circumferential wall of said base flange being offset from said perimeter wall of said strainer cover;
a groove extending into said circumferential wall of said base flange and extending an entire circumference around said base flange; and
an o-ring being positioned within said groove wherein said o-ring is configured to seal said strainer cover to the strainer housing when said strainer cover is positioned over the strainer housing.
